(19) United States
(12) Patent Application Publication
(10) Pub. No.: US 2015/0152838 A1
(43) Pub. Date: Jun. 4, 2015

(54) SPAR CAPS-SHEAR WEB ASSEMBLY CONFIGURATION FOR WIND TURBINE BLADES, AND METHODS THEREOF

(71) Applicant: General Electric Company, Schenectady, NY (US)

(72) Inventors: Thomas Merzhaeuser, Munchen (DE); Bart Jan Veldkamp, Enschede (NL)

(73) Assignee: General Electric Company, Schenectady, NY (US)

(21) Appl. No.: 14/094,079

(22) Filed: Dec. 2, 2013

(51) Int. Cl. F03D 1/06

(52) U.S. Cl. CPC F03D 1/0675

(57) ABSTRACT

A wind turbine blade is presented. The blade includes an upper shell member having a spar cap disposed on an internal surface of the upper shell, and a lower shell member having a spar cap disposed on an internal surface of the lower shell. The spar cap of the upper shell member, the spar cap of the lower shell member or both the spar caps include at least one cavity structure along a longitudinal length of the blade. A shear web extends between the spar caps along the longitudinal length of the blade, with a transverse end of the shear web positioned in a cavity of the at least one cavity structure, wherein a ratio of a width of the shear web to a bond thickness of the shear web with a side wall of the cavity structure is between about 1:1 and about 15:1.

### BACKGROUND OF THE INVENTION

The invention relates generally to wind turbine blades. More particularly, the invention relates to spar caps, and their assembly configuration with shear webs within the wind turbine blades, and methods for assembling shear webs in the wind turbine blades.

Turbine blades are the primary elements of wind turbines for converting kinetic energy in wind into electrical energy. The blades have the cross-sectional profile of an airfoil such that, during operation, air flows over the blade producing a pressure difference between the sides. Consequently, a lift force, which is directed from a pressure side towards a suction side, acts on the blade. The lift force generates torque on the main rotor shaft, which is geared to a generator for producing electricity.

The turbine blades typically consist of a suction side shell and a pressure side shell that are bonded together at bond lines along the trailing and leading edges of the blade. An internal shear web extends between the pressure and suction side shell members, and is bonded to spar caps affixed to the inner faces of the shell members. The shear web should have sufficient dimensions (for example, width) to provide enough surface area to securely bond, by a bond paste for example. Furthermore, relatively exact length dimensions are required for the shear web to span between the spar caps and achieve a bond between the spar caps and the transverse ends of the shear web. Achieving these dimensions, as well as an adequate bond, can be difficult, and forming the juncture between the spar caps and shear web is a time-consuming and tedious process that often requires significant re-work.

Accordingly, it would be desirable to have an improved bond configuration between a shear web and spar caps that addresses one or more of the deficiencies of certain conventional configurations.

### BRIEF DESCRIPTION OF THE INVENTION

One embodiment of the invention is directed to a wind turbine blade. The blade includes an upper shell member having a spar cap disposed on an internal surface of the upper shell, and a lower shell member having a spar cap disposed on an internal surface of the lower shell. The spar cap of the upper shell member, the spar cap of the lower shell member or both the spar caps include at least one cavity structure along a longitudinal length of the blade. A shear web extends between the spar caps along the longitudinal length of the blade, with a transverse end of the shear web positioned in a cavity of the at least one cavity structure, wherein a ratio of a width of the shear web to a bond thickness of the shear web with a side wall of the cavity structure is between about 1:1 and about 15:1.

Another embodiment of the invention is directed to a method of assembling a shear web in a wind turbine blade. The method includes manufacturing a spar cap including at least one cavity structure disposed on an internal surface of an upper shell member, an internal surface of a lower shell member, or both the shell members, along a longitudinal length of a blade, disposing a bonding material within a cavity of the at least one cavity structure, and positioning a transverse end of a shear web in the bonding material within the cavity such as a ratio of a width of the shear web to a bond thickness of the shear web with a side wall of the cavity structure is between about 1:1 and about 15:1.

### DRAWINGS

These and other features and aspects of the present invention will become better understood when the following detailed description is read with reference to the accompanying drawings in which like characters represent like parts throughout the drawings.

FIG. 1 is a prospective view of a conventional wind turbine;

FIG. 2 is a perspective view of a conventional wind turbine blade;

FIG. 3 is a cross-sectional view of a conventional wind turbine blade;

FIG. 4 is an enlarged cross-sectional view of an assembly of a spar cap and a shear web, in accordance with an embodiment of the invention;

FIG. 5 is an enlarged cross-sectional view of an assembly of a spar cap and a shear web, in accordance with another embodiment of the invention;

FIG. 6 is an enlarged cross-sectional view of an assembly of a spar cap and a shear web, in accordance with yet another embodiment of the invention; and

FIG. 7 is an enlarged cross-sectional view of an assembly of a spar cap and a shear web, in accordance with yet another embodiment of the invention.

### DETAILED DESCRIPTION

Approximating language, as used herein throughout the specification and claims, may be applied to modify any quantitative representation that could permissibly vary, without resulting in a change in the basic function to which it is related. Accordingly, a value modified by a term or terms, such as “about,” is not limited to the precise value specified. In some instances, the approximating language may correspond to the precision of an instrument for measuring the value.

In the following specification and claims, the singular forms “a”, “an” and “the” include plural referents unless the context clearly dictates otherwise. As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

The terms “comprising,” “including,” and “having” are intended to be inclusive, and mean that there may be additional elements other than the listed elements. As used herein, the term “and/or” includes any and all combinations of one or more of the associated listed items.

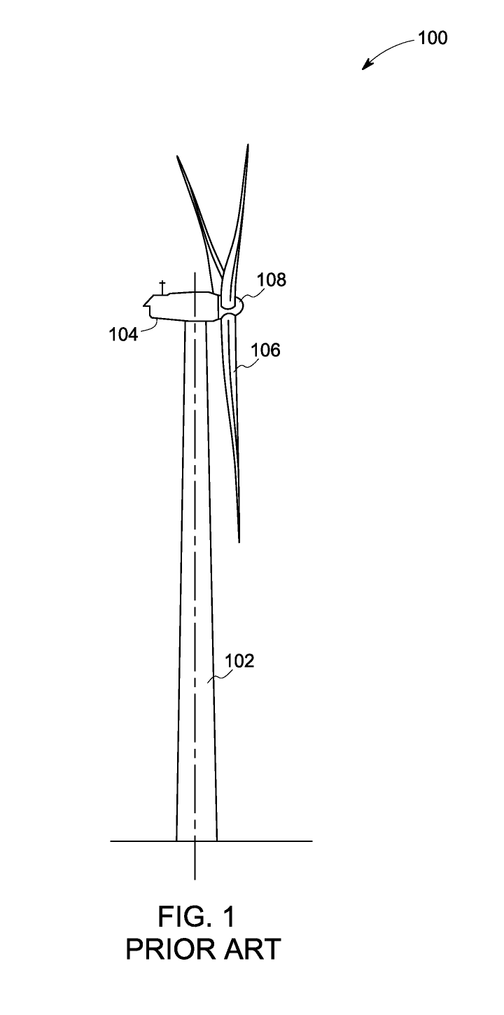

FIGS. 1-3 are provided for illustrative purposes only to place the present invention in an exemplary field of use. It should be appreciated that the invention is not limited to any particular type of wind turbine configuration.

FIG. 1 illustrates a wind turbine 100 of conventional construction. The wind turbine 100 includes a tower 102 with a nacelle 104 mounted thereon. A plurality of turbine blades 106 are mounted to a rotor hub 108, which is in turn connected to a main flange that turns a main rotor shaft. The wind turbine power generation and control components are housed within the nacelle 104.

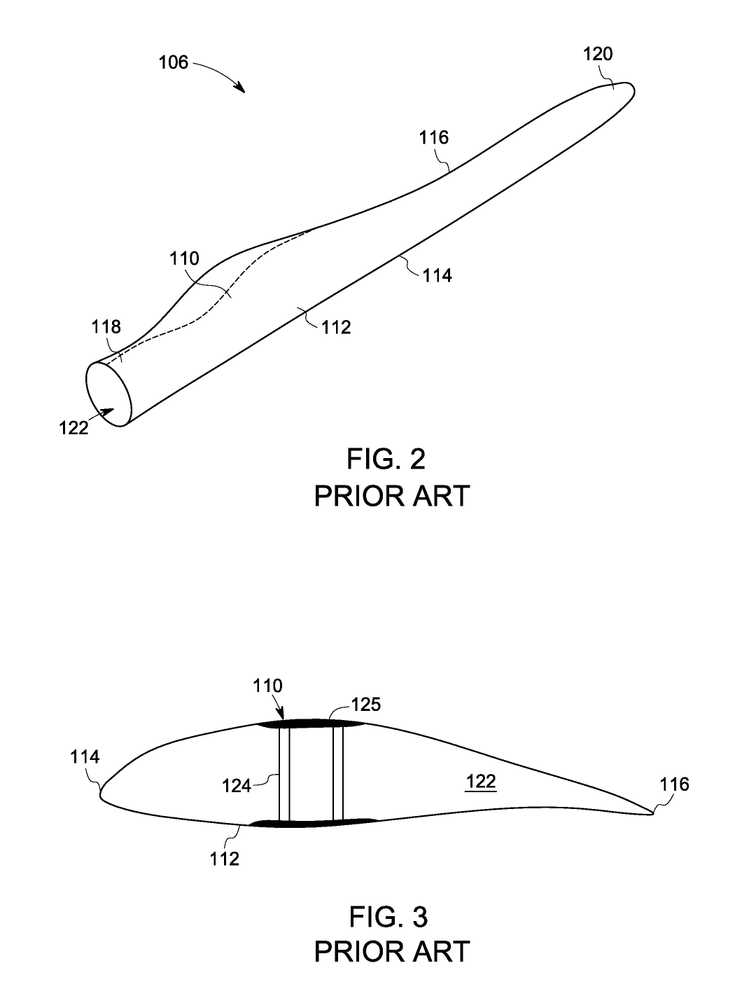

FIG. 2 is a detailed view of a wind turbine blade 106. The blade 106 includes an upper shell member 110 and a lower shell member 112. The upper shell member 110 may be configured as the suction side surface of the blade 106, while the lower shell member 112 may be configured as the pressure side surface of the blade 106. These shell members 110 and 112 are typically fabricated from layers of woven fabric and resin. The blade 106 includes a leading edge 114 and a trailing edge 116, as well as a root portion 118, and a tip portion 120. As is well known in the art, the upper shell member 110, and the lower shell member 112 are joined together at the leading edge 114 and the trailing edge 116. The blade 106 includes an internal cavity 122 (FIGS. 2 and 3) in which various structural members, such as spar caps and one or more shear webs, are configured.

FIG. 3 is a cross-sectional view of a wind turbine blade 106 (FIG. 2). The blade 106 includes one or more internal structural shear webs 124 that span between the upper shell member 110 and lower shell member 112 to form a structural support. In particular, the shear web 124 spans between spar caps 125 that are configured on internal surfaces of the shell members 110 and 112. The shear webs 124 and the spar caps 125 extend at least along a longitudinal length of the blade 106, and are typically, but not necessarily, configured as I-shaped members. A longitudinal length of the blade 106 is the distance between the root portion 118 and the tip portion 120 (FIG. 2), at the opposite ends of the blade 106.

The spar caps 125 are usually fixed to an internal surface of the shell member or placed in the shell member. The spar caps typically comprises of an assemblage of layers of unidirectional (UD) composite fiber. The cross-sections at any section along the length of the spar cap 125 are often rectangular. The fabrication of each of these constituent parts (for example, shell members, spar caps) involves a labor-intensive process that includes for instance, laying out fabric, glass fibers, and/or foam, followed by or with intervening resin application steps.

As used herein, a contact length of a shear web with a bonding material provided between the shear web and a spar cap is referred to as a bond width (BW). The bond width of the shear web may be a measure of the surface area of the shear web bonded to or in contact with the bonding material. A “bond thickness” of a shear web with a spar cap refers to a gap between a portion of the shear web (that is in contact with a bonding material) and a portion of the spar cap, which is usually occupied by the bonding material to join/bond the two portions.

With typical blade construction, the shear web 124 is joined to the spar caps 125 using a bonding material, such as an adhesive or a bond paste. As discussed previously, the length dimension of the shear web should be sufficient to span between the spar caps, and the thickness dimension (i.e., width) should be enough to provide enough surface area (which can be assessed by measuring a bond width BW) to securely bond with the bond paste.

Various designs have been proposed to achieve a desired bond width between the spar caps and the shear web, for example using a shear web with a laminate or c-flange, use of a rigid flange etc. These configurations, however, do not accommodate relatively large length variances (e.g., shortages) in the shear web, and often result in break off and blade “rattling” during operation of the wind turbine. In addition, air voids, unpredictable misalignment, peel-off, and squeeze-out of the bond paste, and insufficient bond width in the typical production processes, can result in areas of decreased bond strength, which is particularly problematic in inaccessible sections of the blade where repair is not possible. Moreover, these production processes involve various testing steps, for example to measure the required bond thickness to determine the required amount of the bond paste, and to ensure minimum required bond width, especially in inaccessible sections of the blade (for example, from about 20 meters from the root portion to the tip portion of a blade). These measurements usually require closing and opening the blade (i.e., joining the upper shell 110 and the lower shell 112) at least once.

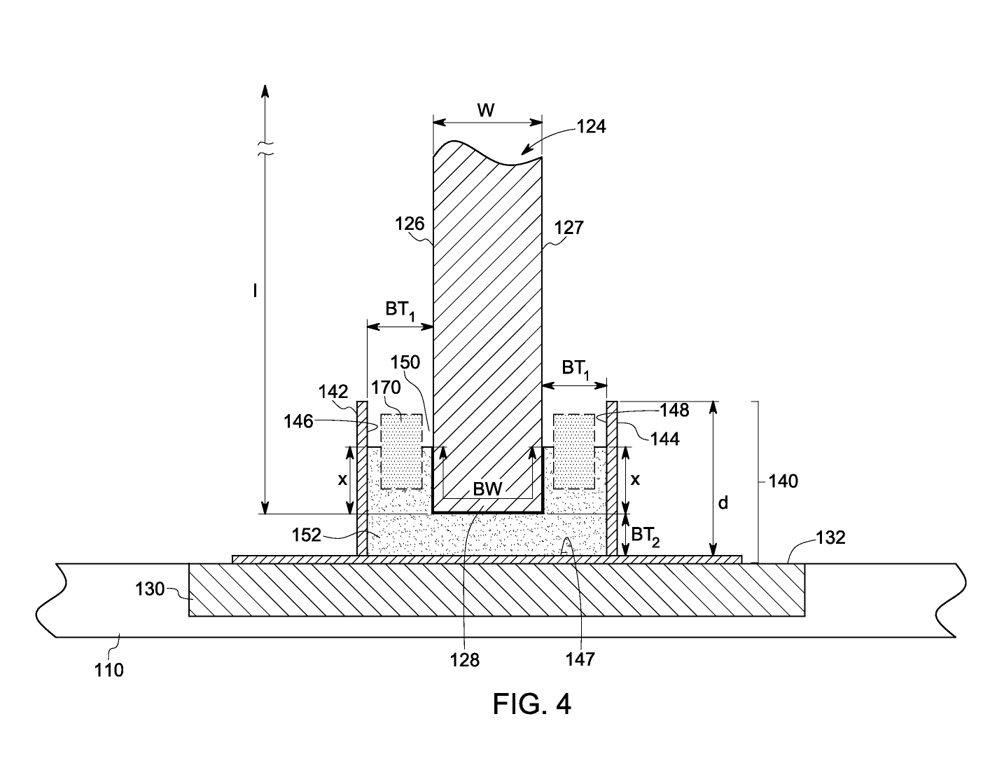

Aspects of the invention described herein address the noted shortcomings of the state of the art. Referring to FIG. 3 again, at least one shell member, the lower shell member 110 or the upper shell member 112, or both members include an improved spar cap 130 (FIG. 4) according to some embodiments of the present invention as described in greater detail below. The present invention also encompasses various method embodiments for assembling the shear web 124 to the improved spar caps 130 within the wind turbine blade.

FIG. 4 depicts an enlarged cross-sectional illustration of a portion of a shell member 110 having an improved spar cap 130 bonded to a shear web 124. In some embodiments, the spar caps 130 may be integrated with the shell members 110. For example, the spar caps 130 may be positioned inside of the internal and outer surfaces of the shell member 110, or may form part of the shell member 110. The spar cap 130 includes a cavity structure 140 configured on a surface 132 of the spar cap 130. The cavity structure 140 includes two parallel side walls 142 and 144 extending away from the surface 132. The side walls 142 and 144 may be about 0.5 millimeters to about 3 millimeters thick. The cavity structure 140 includes a cavity 150 defined by the inner surfaces 146 and 148 of the side walls 142 and 144, and a bottom surface 147 between the extended side walls 142 and 144. In some instances, the bottom surface 147 may be a portion of the surface 132 of the spar cap 130.

The cavity structure 140 can extend fully or partially along the longitudinal length of the spar cap 130. The cavity structure 140 can also be understood to include a longitudinal cavity 150 e.g., a grove. The cross section of the cavity 150 may be cup-shaped with sharp or round corners. During construction of the blade, the cavity structure 140 can be manufactured during the infusion of the spar cap 130 or the shell member 110. Other techniques may be used as well. Various composite fibers may be used for the cavity structure 140 similar to the material used for spar caps. In one embodiment, the cavity structure 140 is formed of a fiber reinforced plastic.

The cavity structure 140 can be positioned substantially at the middle of the spar cap 130 to accept a shear web 124. The cavity 150 may be wide enough to accommodate the shear web 124, and may have a length to define a depth ‘d’ of the cavity 150. In some embodiments, the cavity 150 may have a depth between about 50 millimeters and 150 millimeters, and a width between about 10 millimeters to about 100 millimeters.

The shear web 124 may have a length or height ‘l’ in the span wise direction and a width or thickness ‘w.’ In some instances, the width ‘w’ of the shear web 124 may vary along the longitudinal length of the blade 106 (FIG. 2). In some of these instances, the width of the cavity 150 may also vary accordingly. The shear web 124 can be positioned in the cavity 150 to be joined with the cavity structure 140 of the spar cap 130. In some instances, the transverse end 128 of the shear web 124 is positioned within the cavity 150 so the side walls 142 and 144 of the cavity structure 140 extend along the longitudinal sides (shear web sides) 126 and 127 of the shear web 124. The cavity 150 contains a bonding material (for example, a bond paste) 152 to adhere the shear web 124. In the illustrated embodiments of FIGS. 4-7, the shear web 124 is positioned in the middle of the cavity 152, and substantially perpendicular to the bottom surface 147. In these instances, the transverse end 128 and a portion (of height or length ‘x’) of each of the longitudinal sides 126 and 127 of the shear web 124 along the length ‘l’ is immersed (or encased) into the bonding material 152. These portions of the longitudinal sides 126 and 127 of the shear web 124 immersed into the bonding material 152 may be referred to as “immersion thickness” of the shear web 124. In some other embodiments, the shear web 124 may not be perpendicular to the bottom surface 147, and have varying immersion thicknesses along the longitudinal side walls 126 and 127.

Referring to FIG. 4, the bond width (BW) of the shear web is equal to the addition of the width (w) of the shear web 124 and the immersion thicknesses of the shear web side walls 126 and 127,

Bond Width (BW)=w+x+x

A bond thickness between a portion of thickness ‘x’ of the longitudinal side walls 127 or 126 of the shear web 124 and the corresponding (or closest) side wall 144 or 142 of the cavity 150 is referred to as BT₁, and the bond thickness of the transverse end 128 of the shear web 124 and the bottom surface 147 of the cavity 150 is referred to as BT₂, throughout the specification.

As described previously, the cavity 150 can be sized to have a width greater than the width (w) of the shear web 124, and provides a substantial bond thickness BT₁. As used herein, a substantial bond thickness BT₁ refers to at least about 5 percent of the width (w) of the shear web 124. According to some embodiments of the invention, a ratio of the width of the shear web (w) to the bond thickness BT₁ of the shear web 124 with the cavity side wall (142 or 144) may be between about 1:1 and about 15:1. In certain instances, the ratio may range between about 4:1 and about 14:1. The bond thickness BT₁ may provide a space to the bonding material to squeeze up/down while positioning the shear web 124 into the bonding material 152, and adjust (increase/decrease) the immersion thickness ‘x’ of the shear web 124, to achieve the required bond width (BW) of the shear web. In one embodiment, the bond thickness BT₁ ranges between about 1 millimeter and about 10 millimeters.

In a particular method embodiment, a cavity structure 140 is configured on a surface of the spar cap 130, having two parallel side walls 142 and 144 defining a cavity 150 (as explained previously), along the longitudinal length of the blade 106. A bonding material 152 is disposed within the cavity 150. The shear web 124 is then pushed into the bonding material 152 such that the transverse end 128 and a portion of the shear web 124 are immersed into the bonding material 152. As the shear web 124 pushes into the bonding material 152, the bonding material gets squeezed at BT₁, and rises up along the longitudinal side walls of the shear web 124. That means that the immersion thickness ‘x’ of the shear web 124 increases as the transverse end 128 of the shear web 124 moves inside the bonding material 152. In some embodiments, the shear web 124 can be pushed in the bonding material 152 until predetermined values of the bond thickness BT₂, and/or the bond width (BW) is attained to achieve high bond strength. The method further includes steps of positioning the shear web 124 in the cavity 150 such that a ratio of the width of the shear web (w) to the bond thickness BT₁ may be between about 1:1 and about 15:1. In certain instances, the ratio may range between about 4:1 and about 14:1.

The method may further include providing the bonding material 152 in the cavity 150 in a measured amount and compressing the shear web 124 into the bonding material 152 until a required BW is achieved. A predetermined amount of the bonding material may help in preventing or reducing squeeze-out of the boding material from the cavity 150 during the assembly of the shear web 124 with the cavity structure 140 of the spar cap, while maintaining the required BW and bond thickness BT₂. In one embodiment, the cavity 150 contains at least about 50 percent of the bonding material by volume of the cavity. The volume of the cavity 150 refers to a volume occupied between the parallel side walls 142 and 144 of depth ‘d’ and the bottom surface 147. In some embodiments, the amount of the bonding material may range between about 70 percent and about 90 percent, by volume of the cavity.

In some embodiments, the bond width (BW) of the shear web 124 with the bonding material 152 ranges from about 20 millimeters to about 200 millimeters. The bond thickness BT₂ may be up to about 30 millimeters. In some embodiments, the bond thickness BT₂ ranges from about 1 millimeter to about 30 millimeters.

The above described design of the spar caps, and their bond configuration with the shear web, accommodate large variance in the bond thickness BT₂ and the bond width (BW), which improves strength and tolerance of the bond between the shear web and spar caps. Moreover, the present designs may result in shear stress instead of peel stress and, moreover, uniformly distributed bond stress, which improves the reliability of the bond.

Unlike conventional designs and processes, the aspects of the present invention allow adjusting the bond thickness BT₂ and the bond width BW by changing the immersion thickness of the shear web. The bond width BW is not dependent on the thickness of the shear web, and can be adjusted to achieve sufficient surface area required to have a secure bond of high bond strength. The bond thickness BT₂ can accommodate any length deviations of the shear web, and can be adjusted to provide largest possible tolerance. In addition to several technological advantages, the aspects of the present invention further enable to use cost effective shear webs.

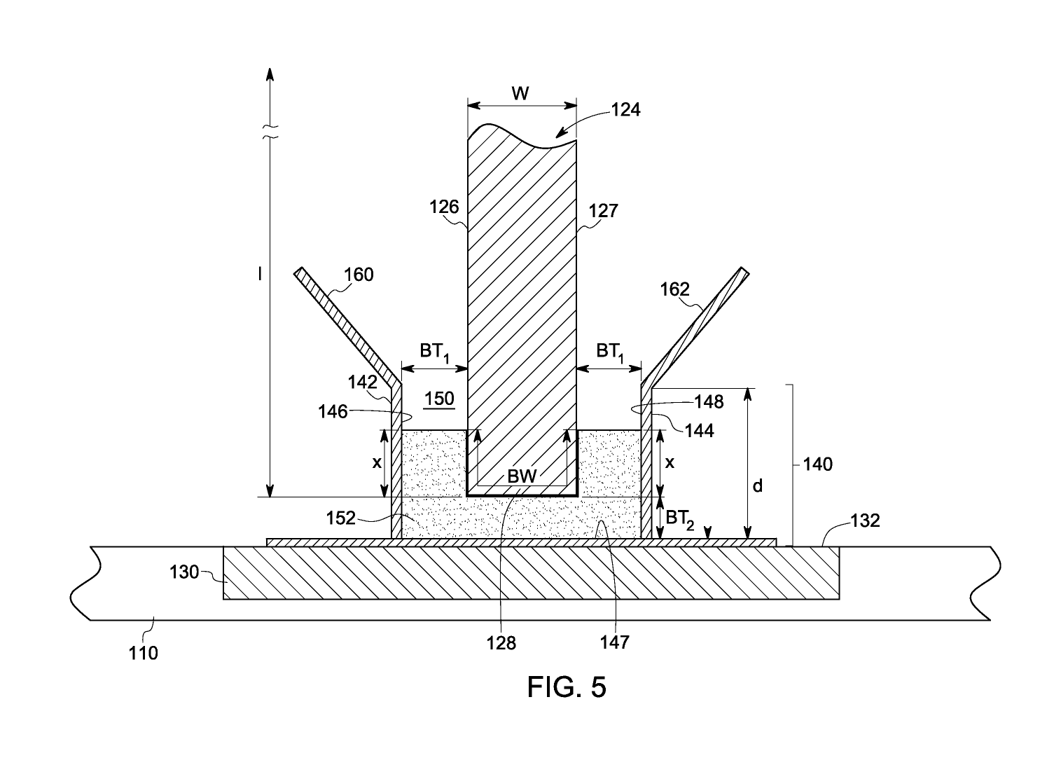

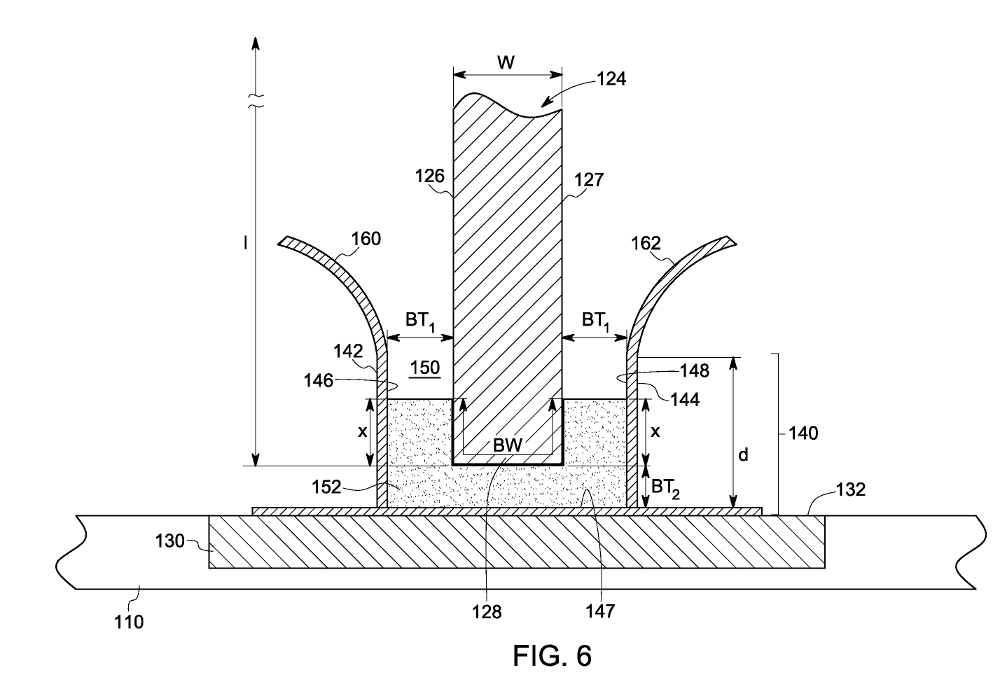

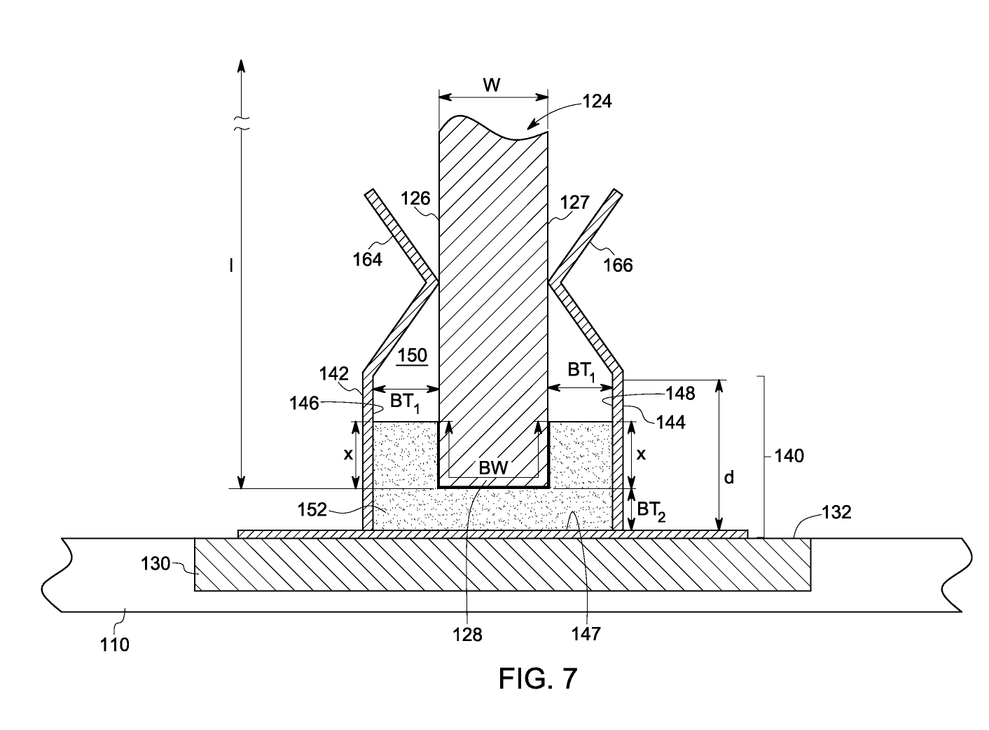

FIGS. 5-8 show several exemplary embodiments including some additional design features. In some embodiments, the cavity side walls 142 and 144 may be extended further from the top end of the U shape cavity 150. FIGS. 5-7 show the extended portions 160, 162. These portions may be helpful in preventing any squeeze out of the bonding material 152. These designs also help to align the shear web 124 in the center of the cavity 150 if misaligned. In some instances, the side walls may be extended in a ‘V’ shape as depicted in FIG. 5. In some other instances, these portions may be shaped rounded as shown in FIG. 6. In some embodiments, a support can be provided to shear web. FIG. 7 depicts extension of the side walls of the cavity in such a way to support the shear web 124. The extended portions may also act as distance holder that can hold the shear web in the center of the cavity. FIG. 5 shows some embodiments that include integrated distance holders 170 introduced at specific locations around the shear web 125 within the gap (bond thickness BT1) between the shear web and the sidewalls of the cavity.

The shape and size of the several components discussed above with reference to FIGS. 1-8 are only illustrative for the understanding of the blade structure, and design and geometry of various components, and are not meant to limit the scope of the invention.

The present invention also encompasses any configuration of a wind turbine 100 (FIG. 1) wherein at least one of the blades 106 includes the spar caps and the shear web assembly configuration as discussed above. As it has been described in detail with respect to specific exemplary embodiments and methods thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Embodiments of the present invention provide advantages to leverage a relatively inexpensive, simple, and rapid process to assemble and join a shear web with the spar caps while manufacturing a wind turbine blade, as compared to currently available methods. The resulting joint/bond may have high strength and reliability due, in part, to improved bond thickness and bond width. Moreover, an additional advantage is the ability to assemble the shear web without several testing steps, and thus to manufacture the blade in simpler steps, as compared to known multi-step, cumbersome manufacturing processes. In brief, the aspects of the present invention simplify the assembly process of shear webs, and improve the reliability and tolerance of the shear web-spar caps bond.

While only certain features of the invention have been illustrated and described herein, many modifications and changes will occur to those skilled in the art. It is, therefore, to be understood that the appended claims are intended to cover all such modifications and changes as fall within the true spirit of the invention. Furthermore, all of the patents, patent applications, articles, and texts which are mentioned above are incorporated herein by reference.

1. A wind turbine blade, comprising:
an upper shell member having a spar cap disposed on an internal surface of the upper shell,
a lower shell member having a spar cap disposed on an internal surface of the lower shell,
wherein the spar cap of the upper shell member, the spar cap of the lower shell member or both the spar caps comprise at least one cavity structure along a longitudinal length of the blade, and
at least one shear web extending between the spar caps along the longitudinal length of the blade, with a transverse end of the shear web positioned in the at least one cavity structure, wherein a ratio of a width of the shear web to a bond thickness of a longitudinal side of the shear web with a side wall of the cavity structure is between about 1:1 and about 15:1.

2. The wind turbine blade of claim 1, wherein the at least one cavity structure comprises a cup-shaped cavity having a bottom wall between the side walls extending away from the spar cap so as to extend along the longitudinal sides of the shear web.

3. The wind turbine blade of claim 2, wherein the cavity has a depth from about 50 millimeters to about 150 millimeters.

4. The wind turbine blade of claim 2, wherein the cavity has a width in a range from about 10 millimeters to about 100 millimeters.

5. The wind turbine blade of claim 1, wherein the spar cap of the upper shell, the spar cap of the lower shell, or both the spar caps comprise an unidirectional composite material.

6. The wind turbine blade of claim 1, wherein the at least one cavity structure comprises fiber-reinforced plastic.

7. The wind turbine blade of claim 2, wherein the cavity structure comprises a bonding material disposed in the cavity.

8. The wind turbine blade of claim 7, wherein the cavity comprises at least about 50 percent bonding material, by total volume of the cavity.

9. The wind turbine blade of claim 1, wherein the transverse end and a portion of the longitudinal side of the shear web are encased in a bonding material.

10. The wind turbine blade of claim 9, wherein the transverse end of the shear web forms a bond with a bottom wall of a cavity, and the portion of the longitudinal side of the shear web forms a bond with a side wall of a cavity structure through the bonding material.

11. The wind turbine blade of claim 10, wherein a bond thickness of the transverse end of the shear web to the bottom wall of the cavity is up to about 30 millimeters.

12. The wind turbine blade of claim 10, wherein a bond thickness of the portion of the longitudinal side of the shear web to the side wall of the cavity structure is in a range from about 1 millimeter to about 10 millimeters.

13. The wind turbine blade of claim 9, wherein a bond width of the shear web with the bonding material is in a range from about 20 millimeters to about 200 millimeters.

14. The wind turbine blade of claim 1, wherein the ratio of the width of the shear web to the bond thickness of the longitudinal side of the shear web with the side wall of the cavity structure is between about 4:1 and about 14:1.

15. A method for assembling a shear web in a wind turbine blade, comprising:
manufacturing a spar cap comprising at least one cavity structure disposed on an internal surface of an upper shell member, an internal surface of a lower shell member, or both the shell members, along a longitudinal length of a blade,
disposing a bonding material within a cavity of the at least one cavity structure,
positioning a transverse end of a shear web in the bonding material within the cavity such as a ratio of a width of the shear web to a with the transverse end and a portion of the longitudinal sides of the shear web encased in the bonding material. bond thickness of a longitudinal side of the shear web with a side wall of the cavity structure is between about 1:1 and about 15:1.
